(19) United States
(12) Patent Application Publication
(10) Pub. No.: US 2020/0215559 A1
(43) Pub. Date: Jul. 9, 2020

(54) COLD SPRAY GUN AND COLD SPRAY APPARATUS EQUIPPED WITH THE SAME

(71) Applicant: PLASMA GIKEN CO., LTD., Saitama (JP)

(72) Inventor: Hirotaka FUKANUMA, Saitama (JP)

(73) Assignee: PLASMA GIKEN CO., LTD., Saitama (JP)

(21) Appl. No.: 16/628,304

(22) PCT Filed: Jun. 29, 2018
(86) PCT No.: PCT/JP2018/024845

§ 371 Date: Jan. 3, 2020

(30) Foreign Application Priority Data
Jul. 5, 2017 (JP) 2017-131921

(51) Int. Cl. B05B 7/16; B05B 7/14; C23C 24/04

(52) U.S. Cl. CPC B05B 7/1626; C23C 24/04; B05B 7/1486

(57) ABSTRACT

The present invention provides a cold spray gun and a cold spray apparatus equipped with the same, which are capable of effectively suppressing clogging of a raw material powder feeding port and operating the cold spray apparatus equipped with the cold spray gun by maintaining a working gas temperature at a high temperature closer to a melting point or a softening point of the raw material powder. In order to achieve the above described object, there is provided a cold spray gun configured to spray out a raw material powder transported by a carrier gas, together with a working gas heated to a temperature equal to or lower than a melting point or a softening point of the raw material powder as a supersonic flow and to cause the raw material powder to collide with a base material in a solid state, thereby to form a coating film.

### TECHNICAL FIELD

The invention disclosed in the present filing relates to a cold spray gun and a cold spray apparatus equipped with the same, which are capable of spraying a raw material powder together with a working gas at a high speed from a nozzle and causing the raw material powder to collide with a base material in a solid state thereby to form a coating film. The invention disclosed in the present filing relates particularly to a raw material powder feeding mechanism.

### BACKGROUND ART

Heretofore, there has been employed a technique for forming a coating film of nickel, copper, aluminum, chromium, or an alloy thereof as various metal parts for the purpose of improving wear resistance and corrosion resistance. Examples of common methods for forming the coating film include an electroplating method, an electroless plating method, a sputtering vapor deposition method, and a plasma thermal spraying method. Recent years have seen attention focused on a thermal spray method and a cold spray method as alternative methods.

Examples of the thermal spray method include low-pressure plasma spraying (LPPS), flame spraying, high-speed flame spraying (HVOF), and atmospheric plasma spraying. These thermal spray methods form a coating film by heating a coating film-forming material and causing the heated coating film-forming material to collide with the surface of a base material at a high speed in the state of molten or semi-molten fine particles.

In contrast, the cold spray method is a method in which a raw material powder transported by a carrier gas is sprayed out from a powder port and charged into a chamber of a cold spray gun supplied with a high-pressure working gas, and the working gas containing the raw material powder is sprayed as a supersonic flow, and the raw material powder is caused to collide with the base material in a solid state thereby to form a coating film. At this time, the temperature of the working gas in the cold spray gun is set to a temperature lower than a melting point or a softening point of the raw material powder such as metals, alloys, intermetallic compounds, and ceramics, which form the coating film. Therefore, it is known that a metal coating film formed using a cold spray method is less susceptible to oxidation or thermal deterioration than metal coating films of the same kind formed by using the method of the related art as described above, and is compact, highly dense, and excellent in adhesion and at the same time, has a high conductivity and a high thermal conductivity.

For example, Patent Literature 1 discloses a cold spray nozzle employing a cold spray method of the related art. The cold spray nozzle disclosed in Patent Literature 1 includes a convergent conical compression unit and a divergent conical expansion unit communicating with the compression unit, wherein raw material powder is fed into a nozzle inlet of the compression unit using a working gas heated to a temperature equal to or lower than a melting point of the powder and is jetted from a nozzle outlet of a distal end of the expansion unit as a supersonic stream, and at least an inner peripheral wall surface of the expansion unit is made of a ceramic material of any one of nitride ceramics, zirconia ceramics, and silicon carbide ceramics.

Further, the cold gas spray gun disclosed in Patent Literature 2 is characterized by being equipped with: a high-pressure gas heater including a cylindrical pressure vessel through which a gas flow to be heated flows and a heater arranged inside the pressure vessel; a mixing chamber capable of supplying particles to the gas flow passing through inside the pressure vessel from outside through a particle supply pipe; and a Laval nozzle formed by continuously connecting a converging passage that converges downstream, a nozzle throat portion, and a diffusion channel. The high-pressure gas heater, the mixing chamber, and the Laval nozzle are continuously connected in sequence from an upstream side of the gas flow. At least a part of a contact surface between the high-pressure gas heater and the gas flow inside the mixing chamber is insulated.

### CITATION LIST

### Patent Literature

### [Patent Literature 1] Japanese Patent Laid-Open No. 2008-253889

### [Patent Literature 2] National Publication of International Patent Application No. 2009-531167

### SUMMARY OF INVENTION

### Technical Problem

As described above, the cold spray nozzle disclosed in Patent Literature 1 supplies a raw material powder into the chamber into which a high-temperature working gas flows, heats the raw material powder to a temperature equal to or lower than a melting point or a softening point of the powder, and then is jetted together with the working gas flow as a supersonic flow from the cold spray nozzle. Since the expansion unit is made of a ceramic material such as nitride ceramics, the cold spray nozzle disclosed in Patent Literature 1 can suppress adhesion of the raw material powder to the cold spray nozzle and nozzle clogging due to this adhesion. However, the powder port formed at a distal end of a raw material powder feeding line for supplying the raw material powder into the chamber is located in the chamber and opened toward the cold spray nozzle near the chamber outlet.

For this reason, the temperature of the powder port itself of the raw material powder feeding line for supplying the raw material powder into the chamber rises to the temperature of the working gas, resulting in that the raw material powder flowing inside the chamber adheres to an inner wall of the powder port, causing powder port clogging. Particularly, in a case in which metals such as aluminum (melting point of approximately 660° C.), tin (melting point of approximately 232° C.), zinc (melting point of approximately 419° C.), copper (melting point of approximately 1083° C.), silver (melting point of approximately 961° C.) or an alloy thereof are used as the raw material powder, when the temperature of the raw material powder exceeds its melting point, the raw material powder naturally adheres to the inner wall of the powder port. Particularly, in a case in which a metal used as a brazing material is used as the raw material powder, when the raw material powder comes into contact with the high-temperature metal, even if the temperature is much lower than the melting point of the raw material powder, the raw material powder adheres to the contact position, causing clogging. Therefore, in order to form a dense and high-quality coating film, the temperature of the working gas should be closer to the melting point or the softening point of the raw material powder, but in fact, the temperature of the working gas has been required to be kept lower to suppress powder port clogging.

Further, as described above, the cold gas spray gun disclosed in Patent Literature 2 provides a mixing chamber between an outlet of the pressure vessel for heating the gas flow and the Laval nozzle, wherein the particle supply pipe is drawn into this mixing chamber from a side of the chamber passing through an outer shell, thereby to supply coating material particles to the gas flow from outside. However, also in Patent Literature 2, since the particle supply pipe is disposed in a state of being drawn into the mixing chamber, the temperature of a raw material powder supply port portion rises to the working gas temperature. Therefore, in the same manner as in Patent Literature 1, in Patent Literature 2, the raw material powder adheres to an inner wall of a particle outlet portion of the particle supply pipe, causing port clogging.

In light of this, there has been a demand in the market for the development of a cold spray gun and a cold spray apparatus equipped with the same, which are capable of effectively suppressing clogging of the raw material powder feeding port and operating the cold spray apparatus equipped with the cold spray gun by maintaining the temperature of the working gas at a high temperature closer to the melting point or the softening point of the raw material powder.

### Solution to Problem

In view of this, as a result of diligent studies, the present inventors have conceived of a cold spray gun and a cold spray apparatus using the same according to the present invention. Hereinafter, the “cold spray gun” and the “cold spray apparatus” will be separately described.

### <The Cold Spray Gun According to the Present Invention>

A cold spray gun according to the present invention is configured to spray out a raw material powder transported by a carrier gas, together with a working gas heated to a temperature equal to or lower than a melting point or a softening point of the raw material powder as a supersonic flow and to cause the raw material powder to collide with a base material in a solid state, thereby to form a coating film, the cold spray gun being characterized by being equipped with: a chamber containing the working gas; a cold spray nozzle having a working gas flow path formed therein, at an outlet of which the working gas discharged from the chamber is sprayed out as a supersonic flow; a raw material powder feeding flow path that supplies the raw material powder to the working gas discharged from the chamber; and a cooling means for cooling the raw material powder feeding flow path.

The cold spray gun according to the present invention is preferably such that the cooling means simultaneously cools an inner wall constituting the working gas flow path.

The cold spray gun according to the present invention is preferably such that the raw material powder feeding flow path is formed to be inclined toward a downstream side of the working gas flow path.

The cold spray gun according to the present invention is preferably such that the raw material powder feeding flow path is formed to be inclined toward an upstream side of the working gas flow path.

The cold spray gun according to the present invention is preferably such that the cooling means is a water-cooled cooling unit equipped with a coolant flow path through which a coolant circulates.

### <The Cold Spray Apparatus According to the Present Invention>

The cold spray apparatus according to the present invention is characterized by being equipped with the above described cold spray gun.

### Advantageous Effects of Invention

The cold spray gun of the present invention is equipped with a cold spray nozzle having a working gas flow path formed therein, at an outlet of which the working gas discharged from the chamber is sprayed out as a supersonic flow; a raw material powder feeding flow path that supplies the raw material powder to the working gas discharged from the chamber; and a cooling means for cooling the raw material powder feeding flow path. Thus, the cold spray gun can suppress the raw material powder in the raw material powder feeding flow path from being heated to a high temperature by the working gas and can maintain the raw material powder in the raw material powder feeding flow path always at a low temperature. Therefore, the cold spray gun can effectively suppress clogging of the raw material powder feeding flow path, and hence can be operated by maintaining the temperature of the working gas at a temperature closer to a melting point or a softening point of the raw material powder to be used than before. As a result, the working gas flow can be sprayed out from the cold spray nozzle at a temperature closer to a melting point or a softening point of the raw material powder, and a dense and high-quality coating film can be formed with a high adhesion efficiency.

### BRIEF DESCRIPTION OF DRAWINGS

FIG. 1 is a schematic diagram illustrating a schematic construction of a cold spray apparatus according to the present embodiment.

FIG. 2 is a schematic cross-sectional perspective view of a cold spray gun according to the present embodiment.

FIG. 3 is a schematic cross-sectional view of the cold spray gun of FIG. 2.

FIG. 4 is a partially enlarged view illustrating a raw material powder feeding flow path of the cold spray gun according to another embodiment.

### DESCRIPTION OF EMBODIMENTS

The present invention is a cold spray gun configured to spray out a raw material powder transported by a carrier gas, together with a working gas heated to a temperature equal to or lower than a melting point or a softening point of the raw material powder as a supersonic flow and to cause the raw material powder to collide with a base material in a solid state, thereby to form a coating film, the cold spray gun being characterized by being equipped with: a chamber containing the working gas; a cold spray nozzle having a working gas flow path formed therein, at an outlet of which the working gas discharged from the chamber is sprayed out as a supersonic flow; a raw material powder feeding flow path that supplies the raw material powder to the working gas discharged from the chamber; and a cooling means for cooling the raw material powder feeding flow path. Hereinafter, embodiments of the cold spray apparatus using the cold spray gun of the present invention will be described with reference to the accompanying drawings.

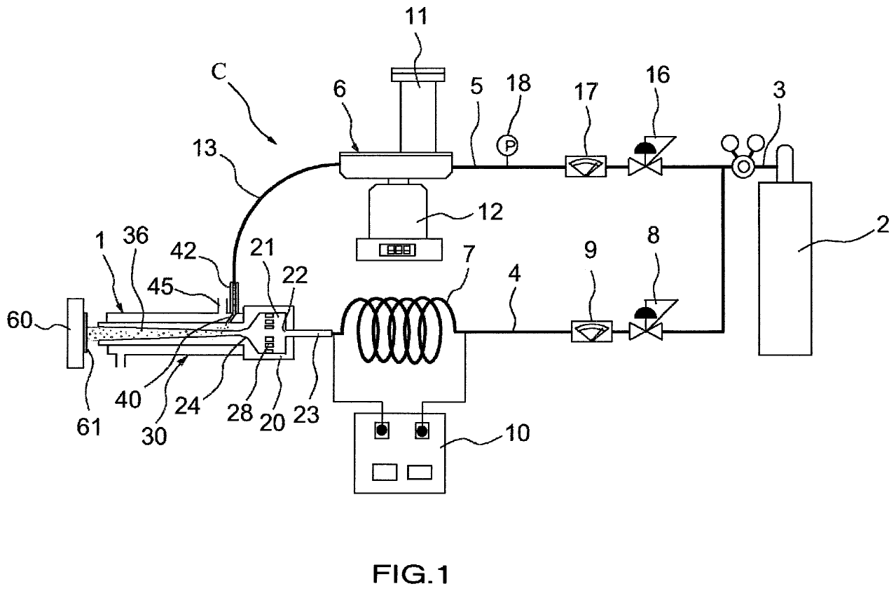

FIG. 1 is a schematic diagram illustrating a schematic construction of a cold spray apparatus C according to the present embodiment. The cold spray apparatus C according to the present embodiment is equipped with: a cold spray gun 1 to which the present invention is applied; a raw material powder feeding device 6 that supplies the raw material powder together with a carrier gas to the cold spray gun 1; and a compressed gas supply unit that supplies a working gas of a specific pressure to the cold spray gun 1 and supplies a carrier gas of a specific pressure to the raw material powder feeding device 6.

Any compressed gas supply unit may be used as long as the compressed gas supply unit can supply a high-pressure gas to the cold spray gun 1 and the raw material powder feeding device 6. In the present embodiment, a compressed gas cylinder 2 containing high-pressure gas is used as the compressed gas supply unit. Therefore, in the present invention, the compressed gas may be supplied from, for example, a compressor or the like.

Examples of the gas used as the working gas supplied to the cold spray gun 1 from the compressed gas supply unit and the carrier gas supplied to the raw material powder feeding device 6 may include helium, nitrogen, air, argon, and a mixed gas thereof. Any gas may be selected according to the raw material powder for use in forming the coating film. To achieve a high linear velocity, helium is preferably used.

In the present embodiment, a gas supply line 3 connected to the compressed gas cylinder 2 branches into a working gas line 4 connected to the cold spray gun 1 and a carrier gas line 5 connected to the raw material powder feeding device 6.

The working gas line 4 includes a heater 7 serving as a heating device that is an electric resistance heating element, inside of which there is formed a working gas flow path. The working gas line 4 includes a pressure regulator 8 and a flow meter 9, which are used to adjust the pressure and the flow rate of the working gas supplied to the heater 7 from the compressed gas cylinder 2. When a voltage is applied from a power source 10 to the heater 7, resistance heat is generated by energization to heat a working gas passing through the working gas flow path formed therein, to a specific temperature equal to or lower than a melting point or a softening point of the raw material powder. In the present embodiment, a heater that is an electric resistance heating element is used as the working gas heating device, but the present invention is not limited to this. Any device may be used as long as the device can heat the working gas under high pressure to a specific temperature equal to or lower than a melting point or a softening point of the raw material powder. An outlet of the working gas line 4 is connected to a chamber 21 of the cold spray gun 1.

An end portion of the carrier gas line 5 is connected to the raw material powder feeding device 6. The raw material powder feeding device 6 is equipped with: a hopper 11 containing the raw material powder; a measure 12 for measuring the raw material powder supplied from the hopper 11; and a raw material powder feeding line 13 for feeding the measured raw material powder together with the carrier gas supplied from the carrier gas line 5 into the chamber 21 of the cold spray gun 1. The carrier gas line 5 includes a pressure regulator 16, a flow meter 17, and a pressure gauge 18, which are used to adjust the pressure and the flow rate of the carrier gas supplied to the raw material powder feeding device 6 from the compressed gas cylinder 2.

Examples of the raw material powder used in the present invention may include metals, alloys, and intermetallic compounds. More specific examples of the raw material powder may include nickel, iron, silver, chromium, titanium, copper, or an alloy thereof.

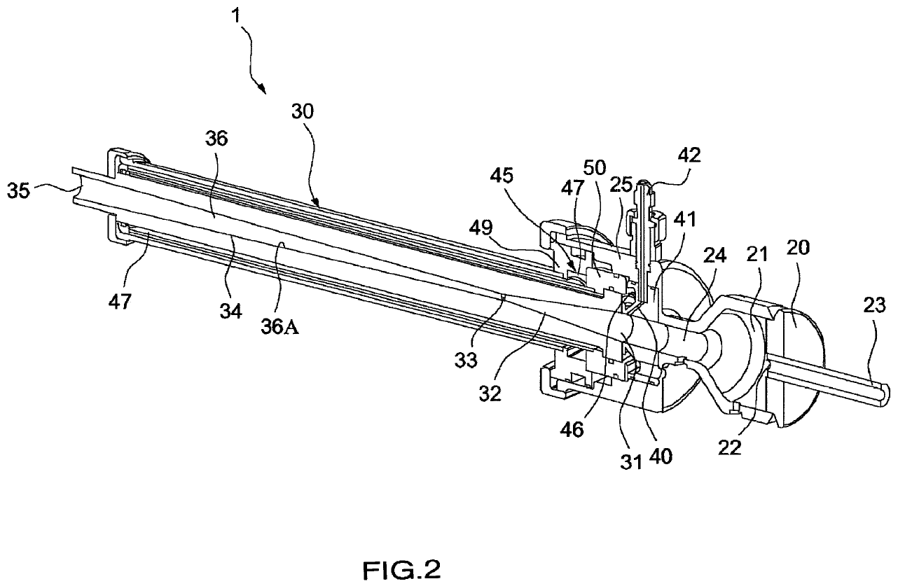

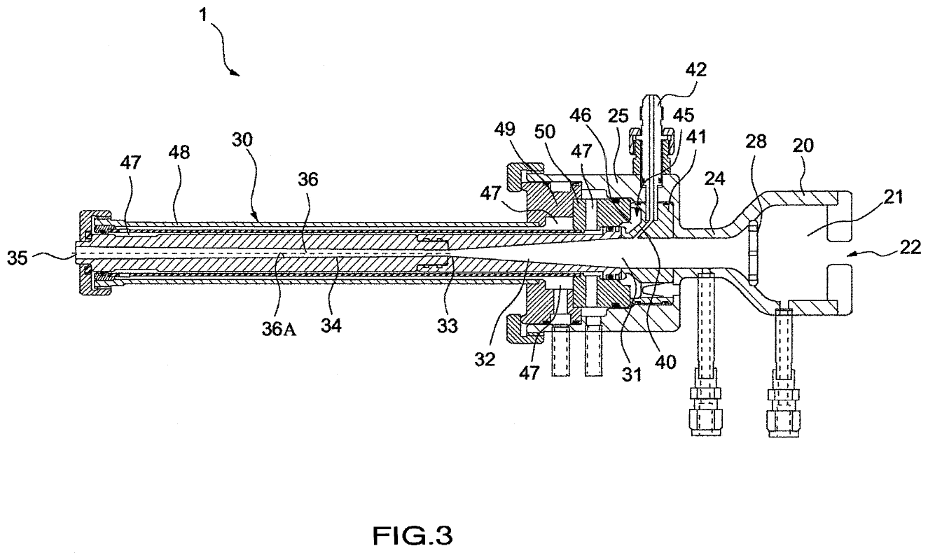

Next, the cold spray gun 1 as an embodiment of the cold spray gun according to the present invention will be described in detail with reference to FIGS. 2 and 3. FIG. 2 is a cross-sectional perspective view of the cold spray gun 1 according to the present embodiment. FIG. 3 is a schematic cross-sectional view of the cold spray gun 1 of FIG. 2.

The cold spray gun 1 is equipped with: a main body 20 defining a chamber 21 containing a high-pressure working gas thereinside; a cold spray nozzle 30 connected to a distal end of the chamber 21; a raw material powder feeding flow path 40 that supplies the raw material powder to the working gas discharged from the chamber 21; and a cooling means for cooling at least the raw material powder feeding flow path 40.

The main body 20 is constituted by a bottomed cylindrical piece having a pressure resistance capable of withstanding a high pressure of, for example, 3 MPa to 10 MPa. The main body 20 is preferably made of a stainless alloy or a nickel-based heat-resistant alloy. A working gas inlet 22 is formed in a bottom portion of this main body 20. The working gas inlet 22 is connected to an outlet of the working gas line 4 through a working gas feeding nozzle 23, from which the working gas heated by the heater 7 flows out. A chamber outlet 24 is formed in the main body 20 of the present embodiment. A nozzle connection portion 25 for connecting the cold spray nozzle 30 is integrally formed at a distal end of the chamber outlet 24. Note that in the drawing, reference numeral 28 denotes a rectifying plate for rectifying a working gas flow in the chamber 21 so as not to be turbulent.

The cold spray nozzle 30 is equipped with: a compression unit 32 formed in a tapered conical shape from a nozzle inlet 31 at the distal end over an extending direction; a narrow throat portion 33 continuing to the compression unit 32, and an expansion portion 34 formed in a divergent conical shape extending from the throat portion 33 to a nozzle outlet 35 at the other end. The compression unit 32, the throat portion 33, and the expansion portion 34 constitutes the working gas flow path 36 extending from the nozzle inlet 31 to the nozzle outlet 35.

The cold spray nozzle 30 may be made of stainless steel, tool steel, cemented carbide alloy, or the like. However, if nickel, copper, aluminum, stainless steel, or an alloy thereof is used as the raw material powder, the raw material powder may adhere to a portion of the nozzle, especially the expansion unit, and further the nozzle may be clogged. Thus, at least the inner wall surface of the cold spray nozzle 30 is preferably made of a glass material, a ceramic material, a tungsten carbide alloy, or the like. The glass material as used herein is not particularly limited, and examples thereof may include silicate glass, alkali silicate glass, soda lime glass, potash lime glass, lead glass, barium glass, and borosilicate glass, but abrasion-resistant glass, specifically silicate glass or alkali silicate glass is preferred. Further, examples of the ceramic material may include silicon nitride ceramics, zirconia ceramics, and silicon carbide ceramics. Note that in the present invention, the material and shape of the cold spray nozzle 30 are not limited to the material and shape described herein, and an existing cold spray nozzle may be employed.

The raw material powder feeding flow path 40 supplies the raw material powder to the working gas after being discharged from the chamber 21 of the main body 20 described above, more preferably to the working gas before flowing into the throat portion 33 of the cold spray nozzle 30. In the present embodiment, the raw material powder feeding flow path 40 is provided on a downstream side of the chamber outlet 24 of the nozzle connection portion 25 of the main body 20 and in the throat portion 33 of the cold spray nozzle 30, more preferably on an upstream side of the nozzle inlet 31.

In the present embodiment, the raw material powder feeding flow path 40 is formed in a raw material powder flow path forming part 41 located in the nozzle connection portion 25 of the main body 20. Like the main body 20, the raw material powder flow path forming part 41 is preferably made of a stainless alloy or a nickel-based heat-resistant alloy having a pressure resistance capable of withstanding a high pressure of 3 MPa to 10 MPa. One end of the raw material powder feeding flow path 40 is connected communicating with a raw material powder feeding nozzle 42 provided in the nozzle connection portion 25. This raw material powder feeding nozzle 42 is connected to the above described raw material powder feeding line 13. The other end of the raw material powder feeding flow path 40 is opened in a flow path formed in the nozzle connection portion 25 through which the working gas flows or in a working gas flow path 36 of the cold spray nozzle 30.

In the present invention, the raw material powder feeding flow path 40 may be connected from a direction substantially perpendicular to a working gas flow direction from the chamber outlet 24 to the throat portion 33 of the cold spray nozzle 30 to supply the raw material powder from the direction substantially perpendicular to the working gas flow direction, but may be formed with a specific inclination angle with respect to the working gas flow direction.

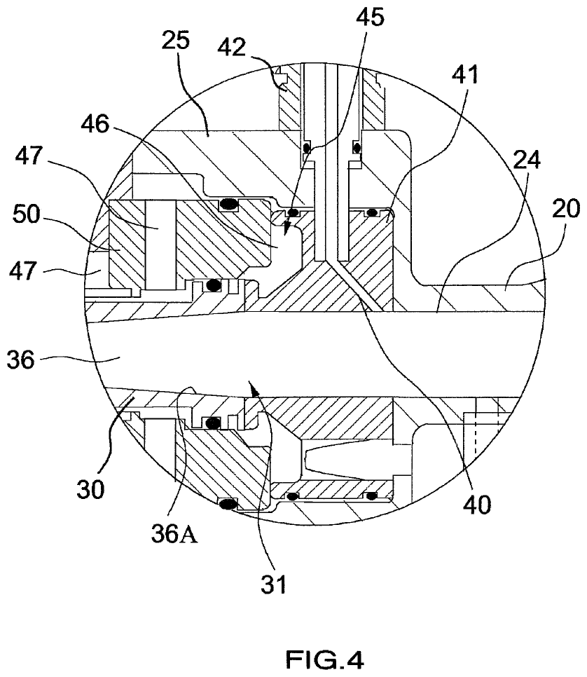

Specifically, in the embodiment illustrated in FIG. 3, the raw material powder feeding flow path 40 is formed to be inclined with a specific inclination angle toward the downstream side of the working gas flow path 36. This configuration can shorten a contact time during which the raw material powder to be supplied to the working gas is in contact with the working gas than a configuration of supplying the raw material powder from the direction substantially perpendicular to the working gas flow direction, and can suppress an increase in temperature of the raw material powder. In contrast, in another embodiment illustrated in FIG. 4, the raw material powder feeding flow path 40 is formed to be inclined at a specific angle toward the upstream side of the working gas flow path 36. This configuration can longer the contact time during which the raw material powder to be supplied to the working gas is in contact with the working gas than a configuration of supplying the raw material powder from the direction substantially perpendicular to the working gas flow direction. Therefore, the raw material powder of a high melting point, such as titanium, tantalum, and Inconel (trademark) can be heated to a high temperature near the melting point. Therefore, the contact time during which the raw material powder to be supplied to the working gas is in contact with the working gas can be adjusted by using a raw material powder flow path forming part 41 selected from a plurality of raw material powder flow path forming parts 41 in which the raw material powder feeding flow path 40 is formed at a different inclination angle with respect to the working gas flow direction.

The cold spray gun 1 according to the present invention is equipped with at least the cooling means for cooling the raw material powder feeding flow path 40 as described above. The cooling means is preferably a water-cooled cooling unit 45 equipped with a coolant flow path 46 through which a coolant circulates. In the present embodiment, the coolant flow path 46 is provided in the raw material powder flow path forming part 41 constituting the raw material powder feeding flow path 40 or at a position where heat can be exchanged with the raw material powder flow path forming part 41. The water-cooled cooling unit 45 constituting the cooling means of the present invention preferably cools the raw material powder feeding flow path 40 and at the same time cools at least an inner wall surface 36A of the working gas flow path 36 of the cold spray nozzle 30.

Specifically, in the present embodiment, the water-cooled cooling unit 45 is equipped with: a series of coolant flow paths 47 formed between a plurality of flow path forming parts 48 to 50 and the cold spray nozzle 30 inside of which there is formed a working gas flow path 36; and a coolant flow path 46 for cooling the above described raw material powder feeding flow path 40. A coolant flow path 47 is formed between a flow path forming part 48 and an outer peripheral surface of the cold spray nozzle 30. A flow path forming part 49 and a flow path forming part 50 are disposed between the nozzle connection portion 25 of the main body 20 and the cold spray nozzle 30 to form the coolant flow path 47 between the nozzle connection portion 25 and the cold spray nozzle 30. The coolant flow path 47 for cooling the inner wall surface of the cold spray nozzle 30 and the coolant flow path 46 for cooling the raw material powder feeding flow path 40 preferably constitute a series of cooling paths. The coolant flowing through the coolant flow paths 46 and 47 is more preferably a countercurrent flow with respect to the flow direction of the working gas flowing through the working gas flow path 36 of the cold spray nozzle 30. This is because the countercurrent flow can efficiently cool the inner wall surface 36A of the working gas flow path 36 through which the working gas flows, and thereby can effectively suppress the adherence of the raw material powder. Note that, in the present invention, the coolant for use in the water-cooled cooling unit 45 is not particularly limited, but for example, cooling water may be used. Note also that in the present embodiment, the cooling means is a water-cooled cooling unit, but the cooling means is not limited to this and any unit may be used as long as the unit can cool at least the raw material powder feeding flow path 40.

With the construction described thus far, an operation of forming a coating film by using the cold spray apparatus C according to the present embodiment will be described. First, a high-pressure working gas is sent to the heater 7 through the gas supply line 3 and the working gas line 4 from the compressed gas cylinder 2 as the high-pressure gas supply unit. Then, the working gas flowing into the heater 7, in the process of passing through the heater 7, is heated to a specific high temperature equal to or lower than a melting point or a softening point of the raw material powder for use in forming the coating film, and then is sprayed into the chamber 21 through the working gas feeding nozzle 23.

Meanwhile, a high-pressure carrier gas is supplied to the raw material powder feeding device 6 from the compressed gas cylinder 2 as the high-pressure gas supply unit through the gas supply line 3 and the carrier gas line 5. While entraining a specific amount of raw material powder measured by the measure 12 of the raw material powder feeding device 6, the high-pressure carrier gas flows into the raw material powder feeding nozzle 42 provided in the cold spray gun 1 through the raw material powder feeding line 13. The raw material powder feeding flow path 40 connected to the raw material powder feeding nozzle 42 is opened toward the working gas flow path extending from the chamber outlet 24 to the throat portion 33 of the cold spray nozzle 30. Therefore, the carrier gas carrying the raw material powder is supplied to a high-speed working gas flow sprayed out from the chamber outlet 24.

The high-speed working gas flow carrying the raw material powder supplied from the raw material powder feeding flow path 40 passes through the throat portion 33 from the compression unit 32 of the cold spray nozzle 30 becomes a supersonic flow, and further is sprayed from the nozzle outlet 35 located at the distal end of the expansion portion 34 formed in a divergent conical shape. The raw material powder sprayed from the cold spray nozzle 30 collides with a surface of a base material 60 in a solid state and accumulates to form a coating film 61.

At this time, the raw material powder flow path forming part 41 forming the raw material powder feeding flow path 40 is equipped with a coolant flow path 46 through which a coolant circulates. Therefore, even if the cold spray nozzle 30 is heated by the working gas flow, the raw material powder feeding flow path 40 can always maintain a low temperature without being heated to a specific high temperature equal to or lower than a melting point or a softening point of the raw material powder. Thus, the raw material powder in the raw material powder feeding flow path 40 can be effectively suppressed from being heated to a high temperature by the working gas, and the raw material powder in the raw material powder feeding flow path 40 can be always maintained at a low temperature. Thus, even if the metal powder used as the raw material powder contacts and adheres to a high-temperature metal at a temperature considerably lower than the melting point, the metal powder can be maintained at a low temperature until just before joining the working gas by the water-cooled cooling unit 45. Thus, such a disadvantage can be effectively suppressed that the raw material powder clogs the raw material powder feeding flow path 40. Therefore, the working gas temperature can be set to a temperature closer to a melting point or a softening point of the raw material powder without considering the clogging of the raw material powder flow path, and a dense and high-quality coating film can be formed with a high adhesion efficiency.

Further, as described above, the coolant flow path 46 for cooling the raw material powder feeding flow path 40 is equipped with the cold spray nozzle 30, inside of which the working gas flow path 36 is formed; the coolant flow path 47 formed between itself and a flow path forming part 50; and the water-cooled cooling unit 45 constituting a series of coolant flow paths. Thus, by circulating a coolant in the water-cooled cooling unit 45, the raw material powder feeding flow path 40 can be cooled, and at the same time the inner wall surface 36A of the working gas flow path 36 of the cold spray nozzle 30 can also be cooled. Thus, the inner wall surface 36A of the working gas flow path 36 through which the working gas flows can also be efficiently cooled, which can effectively suppress a disadvantage that the raw material powder adheres to the inner wall surface 36A of the working gas flow path 36 on a downstream side of the raw material powder feeding flow path 40.

### INDUSTRIAL APPLICABILITY

The cold spray gun and the cold spray apparatus according to the present invention can effectively suppress a disadvantage that the raw material powder is heated by a high-temperature working gas in the raw material powder supply path and adheres to the inner wall, causing clogging. Thus, the working gas temperature can be set to a high temperature closer to a melting point or a softening point of the raw material powder without considering the clogging of the raw material powder in the raw material powder supply path. Therefore, a dense and high-quality coating film can be formed with a higher adhesion efficiency than before.

### REFERENCE SIGNS LIST

C cold spray apparatus
1 cold spray gun
2 compressed gas cylinder (high-pressure gas supply unit)
3 gas supply line
4 working gas line
5 carrier gas line
6 raw material powder feeding device
7 heater
13 carrier gas line
20 main body
21 chamber
22 working gas inlet
23 working gas feeding nozzle
24 chamber outlet
25 nozzle connection portion
30 cold spray nozzle
31 nozzle inlet
32 compression unit
33 throat portion
34 expansion portion
35 nozzle outlet
36 working gas flow path
36A inner wall surface
40 raw material powder feeding flow path
41 raw material powder flow path forming part
42 raw material powder feeding nozzle
45 water-cooled cooling unit
46, 47 coolant flow path
60 base material
61 coating film

1. A cold spray gun configured to spray out a raw material powder transported by a carrier gas, together with a working gas heated to a temperature equal to or lower than a melting point or a softening point of the raw material powder as a supersonic flow and to cause the raw material powder to collide with a base material in a solid state, thereby to form a coating film,
the cold spray gun comprising: a chamber containing the working gas; a cold spray nozzle having a working gas flow path formed therein, at an outlet of which the working gas discharged from the chamber is sprayed out as a supersonic flow; a raw material powder feeding flow path that supplies the raw material powder to the working gas discharged from the chamber; and a cooling means for cooling the raw material powder feeding flow path.

2. The cold spray gun according to claim 1, wherein the cooling means simultaneously cools an inner wall constituting the working gas flow path.

3. The cold spray gun according to claim 1, wherein the raw material powder feeding flow path is formed to be inclined toward a downstream side of the working gas flow path.

4. The cold spray gun according to claim 1, wherein the raw material powder feeding flow path is formed to be inclined toward an upstream side of the working gas flow path.

5. The cold spray gun according to claim 1, wherein the cooling means is a water-cooled cooling unit equipped with a coolant flow path through which a coolant circulates.

6. A cold spray apparatus comprising the cold spray gun as claimed in claim 1.
